(19) United States
(12) Patent Application Publication
(10) Pub. No.: US 2012/0316268 A1
(43) Pub. Date: Dec. 13, 2012

(54) METHOD OF REDUCING THE EMISSION OF FORMALDEHYDE FROM FORMALDEHYDE LADEN WOOD PRODUCTS

(75) Inventor: Georges Francis, Compiegne (FR)

(73) Assignee: ADVACHEM SA

(21) Appl. No.: 13/428,702

(22) Filed: Mar. 23, 2012

(30) Foreign Application Priority Data
Jun. 10, 2011 (EP) 11 447 012.3

(51) Int. Cl. C08L 97/02

(52) U.S. Cl. 524/14

(57) ABSTRACT

A method for the production of wood material articles with low emissions of formaldehyde is provided wherein the applied wood is treated with modified ammonium polyphosphate before bonding. When using formaldehyde resins in the bonding agent, wood material articles can be produced with the inventive method with extremely low formaldehyde emissions.

This application claims the benefit of European Patent Office application serial no. 11 447 012.3, the entire disclosure of which is incorporated herein by reference.

### BACKGROUND OF THE INVENTION

1. Field of the Invention

The present invention relates to a method of reducing the emission of formaldehyde from formaldehyde laden products, such as particle boards or fiber boards. It also relates to an aqueous solution comprising modified ammonium polyphosphate for use in the method. The method, according to the present invention, comprises a treatment step of the fibers or the particles of wood with the aqueous solution comprising modified ammonium polyphosphate, mentioned hereafter as MAPP, before contacting the fibers and/or particles with the resin, possibly after a drying step.

2. Description of Related Art

Most of the wood panels produced in Europe are agglomerated with formaldehyde based binders which remain a good compromise between cost, performance and ease of use for such applications. These binders are thermosetting resins obtained by polycondensation of formaldehyde, urea and, possibly, melamine. Typically, these adhesive compositions contain a substantial molar excess of formaldehyde. Some of this excess is released upon curing of the resin during the manufacture of the panel. However, it is well known that formaldehyde continues to be released from these panels even after the manufacturing process is completed.

Thus, formaldehyde released in the indoor air has been a major concern for many years.

Several attempts have been made for many years for reducing formaldehyde emission:
Modification of the glue by decreasing the molar ratio formaldehyde/urea
Addition of amino-compounds to the gluing mixture, like urea (NH₂CONH₂), during the manufacture of the panel (for example JP2000/087541 discloses a wax mixing comprising urea as formaldehyde catcher)
Mixing the formaldehyde based resin with other gluing material
Increasing the press factor.
Using free formaldehyde binders

However, all these methods entail significant mechanical, chemical, environmental or economical disadvantages. It was therefore necessary and urgent to propose an efficient solution to avoid these drawbacks, allowing the manufacture of wood panels with low formaldehyde emission.

Chinese patent application CN101412231 discloses a method for producing flame-retardant glued board or veneer plywood. In said method, the wood veneers are placed into a flame retardant aqueous solution. The veneers are then coated on the upper and lower faces with adhesive and dried. The coated veneers are assembled into plate. The flame retardant used in this method is a mixture of low ammonium polyphosphate, ammonium phosphate, ammonium pyrophosphate, urea phosphate, boric acid and pentaerythritol.

Japanese patent application JP2000087541 discloses a method to contrive the reduction of release of formaldehyde in a room by painting the wooden floor with a wax containing a formaldehyde catcher.

U.S. Pat. No. 3,976,752 relates to a method for preparing crystalline, water-insoluble ammonium polyphosphates of controlled pH to impart flame retardance to plastic and wood particles boards.

Ammonium polyphosphate (APP) is an inorganic salt of polyphosphoric acid and ammonia. The chain length (n) of this polymeric compound is both variable and branched, and can be greater than 1000. Short and linear chain APPs (n<100) are more water sensitive (hydrolysis) and less thermally stable than longer chain APPs (n>1000), which show a very low water solubility (<0.1 g/100 ml).

Chemical Formula and structure: [NH₄ PO₃],

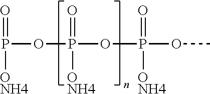

### Formula 1: APP Structure

APP is a stable, non-volatile compound. In contact with water APP it slowly gets hydrolysed to monoammonium phosphate (orthophosphate). Higher temperatures and prolonged exposure to water will accelerate the hydrolysis. Long chain APP starts to decompose at temperatures above 300° C. to polyphosphoric acid and ammonia. Short chain APP will begin to decompose at temperatures above 150° C.

CA1054918 discloses particle board comprising Ammonium polyphosphate as fire-retardant agent. Such ammonium polyphosphate is not a formaldehyde catcher.

### SUMMARY OF THE INVENTION

Accordingly, the present invention provides a method of reducing the emission of formaldehyde from wood-based panels containing formaldehyde-based resins, by which the above mentioned problems due to formaldehyde are overcome.

The method according to the invention comprises treatment before use of the fibers or the particles of wood (possibly agglomerated to form a layer or thin sheet) with a (advantageously aqueous) solution or suspension comprising ammonium polyphosphate, urea or a modified ammonium polyphosphate, mentioned hereafter as MAPP.

In the present application, various wordings are used with broad meanings, said wordings being for example:

“Wood containing particles and fibers” or “wood particles and fibers” or “wood containing elements” mean in the present application particles and fibers produced or prepared from wood and/or wood residues, cellulose containing particles and fibers, and particles from paper, cardboard, and the like. The wood containing particles and fibers can be mixed with other particles and fibers, such as with glass fibers, glass beads, hollow glass beads, etc. The wood containing particles and fibers are advantageously free or substantially free of organic binder. The wood containing particles and fibers can be shaped or have the form of thin layers or lamellas, which are, for example, intended to be glued together by means of a formaldehyde glue for forming a layered structured product.

By “formaldehyde laden products” is herein meant products, such as panels, comprising at least (a) wood containing elements selected from the group consisting of wood containing particles, wood containing fibers and mixtures thereof, and (b) a formaldehyde based resin system.

By “formaldehyde resin system” or “formaldehyde based resin system” is herein meant an adhesive system based on a curable resin system containing formaldehyde, such as an amino formaldehyde resin or a phenolic formaldehyde resin or mixture thereof. The resin system can possibly comprise non formaldehyde resin, provided said other resin is compatible with the formaldehyde based resin. Important properties of a formaldehyde resin system or adhesive include adhesive strength, curing time and temperature, water-resistance and emission of formaldehyde. Specific examples are urea-formaldehyde resins, phenol-formaldehyde resins and mixtures thereof.

By “wood-based panels” or “wood laden panels” is herein meant “particle board panel, MDF (medium density fiber board panel) and plywood”; said panels can possibly contain particles and fibers which are not wood containing particles and fibers. Wood based panels or wood laden panels means also layered products, such as product comprising a series of wood thin layers glued together with interposition with a formaldehyde based glue.

The invention relates thus to a method of production of formaldehyde laden products comprising at least (a) wood containing elements selected from the group consisting of wood containing particles, wood containing fibres and mixtures thereof, and (b) a formaldehyde based resin system, with reduced emission of formaldehyde during the production of said products, as well as from said products after their production, wherein the method comprises at least the following steps:
treating the wood containing elements with an aqueous composition comprising at least a reaction product (MAPP) of a reagent selected from the group consisting of melamine, urea and mixtures thereof with an ammonium polyphosphate compound selected from the group consisting of ammonium polyphosphate having a water solubility at 25° C. greater than 0.5 g/100 ml, ammonium polyphosphate having a weight average particle size of less than 50 μm, and combinations thereof, wherein the said aqueous composition is selected from the group consisting of aqueous solution, aqueous suspension and a mix thereof, wherein the weight ratio ammonium polyphosphate/reagent used for the preparation of the said reaction product is comprised between 1:1 and 25:1, advantageously between 2:1 and 15:1, and preferably between 5:1 and 12:1;
mixing the wood containing elements treated with the said aqueous composition with a formaldehyde based resin system, and
hardening the formaldehyde based resin system mixed with the wood containing elements treated with the said aqueous composition.

In said method, the reaction product advantageously has a water solubility at 25° C. greater than 2 g/100 ml, preferably greater than 10 g/100 ml, most preferably greater than 20 g/100 ml, and particularly preferred, for example, from 15 g to 50 g/100 ml.

Embodiments of the method of the invention comprise one or more of the following characteristics or details, and advantageously a combination of such characteristics and details:
after hardening the formaldehyde based resin system, the dry weight ratio reaction product/formaldehyde based resin system is comprised between 1:100 and 1:3, advantageously comprised between 1:20 and 1:4, preferably comprised between 1:10 and 1:4; and/or
the said aqueous composition has a solid content in reaction product, ammonium polyphosphate, and reagent in the range from 50 to 70% by weight, and/or
the said aqueous composition contains at least the reaction product of ammonium polyphosphate with urea, and/or
the reaction product is the reaction product of urea with ammonium polyphosphate of formula

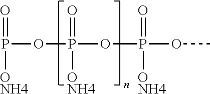

with n less than 10, advantageously comprised between 2 and 8, most preferably between 2 and 6; and/or
the composition is suspension being substantially free of compound of formula

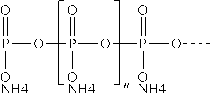

with n greater than 10, advantageously with n greater than 8, said compound being possibly reacted with urea; and/or
the wood containing elements are treated with the said aqueous composition comprising the said reaction product at a temperature comprised between 25° C. and 150° C., advantageously between 35° C. and 100° C., preferably at a pressure higher than 10⁵ Pa, most preferably comprised between 2 10⁵ Pa and 10⁶ Pa; and/or
the wood containing elements are mixed with the formaldehyde based resin system for preparing after hardening of the said formaldehyde based resin system, wood containing boards selected from the group consisting of particle boards, medium density fiber boards, and plywood boards; and/or
the wood containing elements are mixed to an aqueous composition containing urea and ammonium polyphosphate during the at least partial reaction of urea with ammonium polyphosphate; and/or
the wood containing element are treated with the said aqueous composition comprising the said reaction product under an ammonia containing atmosphere; and/or
the wood containing elements after being treated with the said aqueous composition containing the said reaction product are removed from the aqueous composition, and then dried, before being mixed with formaldehyde based resin system, and/or
the wood containing elements after being treated with the said aqueous composition containing the said reaction product are removed from the aqueous composition, and then dried at a temperature below 150° C., advantageously below 130° C., for example comprised between 25° C. and 100° C., before being mixed with formaldehyde based resin system, and/or
the wood containing elements after being treated with the said aqueous composition containing the said reaction product are removed from the aqueous composition, and then dried for reducing the water content of the treated wood containing element below 10% by weight, advantageously below 5% by weight, preferably below 3% by weight, before mixing the dried treated wood containing elements with the formaldehyde based resin system, and/or
the wood containing elements are first treated an aqueous composition containing ammonium polyphosphate, then treated with an aqueous composition containing at least urea as reagent, wherein the reaction of the said ammonium polyphosphate with urea is started so as to form the said reaction product in the aqueous composition, and wherein the wood containing elements are treated with the aqueous composition containing the so prepared reaction product, and/or
the average value for “n” in weight for the said APP compound is comprised between 2 and 6, the solution or suspension being substantially free of compound of formula

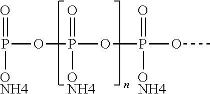

with n greater than 10, advantageously greater than 8, and/or
said solution or suspension contains at least a modified ammonium polyphosphate (MAPP) issued from the reaction of ammonium polyphosphate with urea, and wherein the modified ammonium polyphosphate (MAPP) is used in an amount of 1-25 kg per ton of wood containing particles or/and fibers, and/or
the wood containing particles or fibres are mixed to an aqueous solution or suspension containing urea and ammonium polyphosphate during the reaction of urea with ammonium polyphosphate.

The invention relates also to a formaldehyde laden products with a reduced emission of formaldehyde, said products comprising at least: (a) wood containing elements selected from the group consisting of wood containing particles, wood containing fibers and mixtures thereof, and (b) a formaldehyde based resin system, wherein, before hardening of the formaldehyde based resin system and before mixing the wood containing elements with the formaldehyde based resin system, the wood containing elements are treated with an aqueous composition comprising at least a reaction product (MAPP) of a reagent selected from the group consisting of melamine, urea and mixtures thereof with an ammonium polyphosphate compound selected from the group consisting of ammonium polyphosphate having a water solubility at 25° C. greater than 0.5 g/100 ml, ammonium polyphosphate having a weight average particle size of less than 50 μm, and combinations thereof, wherein the aqueous composition is selected from the group consisting of an aqueous solution, an aqueous suspension and a mix thereof, and wherein the weight ratio ammonium polyphosphate/reagent used for the preparation of the said reaction product is comprised between 1:1 and 25:1.

The products of the invention may have one or more of the following characteristics, or a combination thereof:
the products are prepared by a method of the invention having one or more characteristics disclosed here above; and/or
the dry weight ratio reaction product/formaldehyde based resin system is comprised between 1:100 and 1:3, advantageously between 1:20 and 1:4, preferably between 1:10 and 1:4, and/or
the reaction product is the reaction product of urea with ammonium polyphosphate of formula

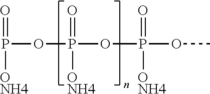

with n less than 10, advantageously comprised between 2 and 8, preferably between 2 and 6; and/or
the product is substantially free of product of formula

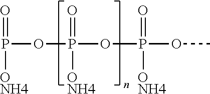

with n greater than 10, possibly comprising one or more amino groups.

The invention relates also to a product comprising at least wood containing particles and/or fibers and at least a formaldehyde based resin system for bonding together at least the wood containing particles and/or fibers, said product being produced by a method according to the invention, so as to reduce the emission of formaldehyde during the production of said products, as well as after the production.

Suitably, the reaction product (MAPP) can be used in an amount of 1-25 kg/ton of wood containing particles or fibers, and preferably 5-20 kg/ton of wood containing particles or fibers.

### DETAILED DESCRIPTION OF THE INVENTION

### Examples

### Example 1

### Preparation of Aqueous Solution/Suspension of APP and Urea and/or MAPP

Various aqueous compositions have been prepared by mixing in water different ammonium polyphosphate with urea, possibly followed by partial or complete reaction between ammonium polyphosphate and urea. The solution or suspension was prepared so as to have a solid content comprised between 50 and 75%, such as a solid content of about 60%.

The following ammonium polyphosphates [NH₄ PO₃]ₙ have been used as starting material:

APP1: [NH₄ PO₃]ₙ with n having as average value about 10 and a P₂O₅ weight content of about 60%, the weight average particle size being comprised between 5 μm and 20 μm
APP2: [NH₄ PO₃]ₙ with n having as average value about 20 and a P₂O₅ weight content of about 65%, the weight average particle size being comprised between 5 μm and 20 μm
APP3: [NH₄ PO₃]ₙ with n having as average value about 30 and a P₂O₅ weight content of about 69%, the weight average particle size being comprised between 5 μm and 20 μm
APP4: [NH₄ PO₃]ₙ with n having as average value about 5 and a P₂O₅ weight content of about 69%, the weight average particle size being comprised between 5 μm and 20 μm. The compound is substantially free of compounds [NH₄ PO₃]ₙ with n greater than or equal to 10.
APP5: [NH₄ PO₃]ₙ with n having as average value about 3 and a P₂O₅ weight content of about 69%, the weight average particle size being comprised between 5 μm and 20 μm. The compound is substantially free of compounds [NH₄ PO₃]ₙ with n greater than or equal to 8.
APP6: [NH₄ PO₃]ₙ with n having as average value about 4 and a P₂O₅ weight content of about 70%, the weight average particle size being comprised between 5 μm and 20 μm. The compound is substantially free of compounds [NH₄ PO₃]ₙ with n greater than or equal to 8.
APP7: [NH₄ PO₃]ₙ with n having as average value about 2.5 and a P₂O₅ weight content of about 70%, the weight average particle size being comprised between 5 μm and 20 μm. The compound is substantially free of compounds [NH₄ PO₃]ₙ with n equal to 1 and free of compounds [NH₄ PO₃]ₙ with n greater than or equal to 5.
APP8: [NH₄ PO₃]ₙ with n having as average value about 3.5 and a P₂O₅ weight content of about 70%, the weight average particle size being comprised between 5 μm and 20 μm. The compound is substantially free of compounds [NH₄ PO₃]ₙ with n greater than or equal to 5.
urea: (NH₂CONH₂), with a weight average particle size comprised between 100 μm and 2000 μm.
MAPP(X): reaction product of APPX (with X being an integer between 1 and 8) with urea, said reaction being carried out in an aqueous medium, at a sufficient temperature comprised between 20° C. and 200° C. (advantageously at a temperature comprised between 20° C. and 100° C.) and, if required or desired, under pressure, for a time required for having the partial or complete reaction of the APPX present in the reaction medium.

The following table gives the composition of the several solutions or suspensions (“S”) which were prepared. In said table, R designates the weight ratio between APPX and Urea before any reaction between APPX and Urea, and P designates the percentage of reaction product (MAPPX) present in the solution or suspension, expressed as weight percentage of APPX having reacted with Urea.

When mixtures of AAPX's are used, the percentage of a compound APPX is the percentage by weight of said compound with respect to the total weight of the APPX's used for the preparation of the solution or suspension.

The solution or suspension can contain one or more additives, such as surfactant, phosphoric acid, boric acid, borax, etc.

| S | APPX | R | P | Comments |
|---|---|---|---|---|
| 1 | APP1 | 6 | 0 | |
| 2 | APP1 | 6 | 25 | |
| 3 | APP1 | 6 | about 50 | |
| 4 | APP1 | 10 | 0 | |
| 5 | APP1 | 10 | 25 | |
| 6 | APP1 | 10 | about 50 | |
| 7 | APP2 | 10 | 25 | |
| 8 | APP3 | 10 | 25 | |
| 9 | APP4 | 10 | 25 | |
| 10 | AAP5 | 10 | 25 | 1% borax present |
| 11 | AAP6 | 10 | 25 | 1% borax present |
| 12 | APP7 | 10 | 25 | |
| 13 | APP8 | 10 | 25 | |
| 14 | APP2 | 10 | 50 | 1% borax present |
| 15 | APP3 | 10 | 50 | |
| 16 | APP4 | 10 | 50 | 1% borax present |
| 17 | APP5 | 10 | 50 | |
| 18 | APP6 | 10 | 60 | |
| 19 | APP7 | 10 | 70 | |
| 20 | APP8 | 10 | 80 | |

| S | APPX | R | P (%) | borax (%) |
|---|---|---|---|---|
| 21 | 25% APP1 + 75% APP3 | 6 | 0 | |
| 22 | 50% APP1 + 50% APP4 | 6 | 50 | |
| 23 | 50% APP1 + 50% APP6 | 6 | 60 | |
| 24 | 25% APP1 + 75% APP3 | 10 | 0 | |
| 25 | 50% APP1 + 50% APP4 | 10 | 50 | |
| 26 | 50% APP1 + 50% APP6 | 10 | 75 | |
| 27 | 50% APP2 + 50% APP6 | 10 | 50 | |
| 28 | 50% APP3 + 50% APP6 | 10 | 50 | |
| 29 | 50% APP4 + 50% APP6 | 10 | 50 | |
| 30 | 50% AAP5 + 50% APP6 | 10 | 50 | |
| 31 | 50% AAP6 + 25% APP1 + 25% | 10 | 50 | |
| | APP2 | | | |
| 32 | 50% APP7 + 50% APP6 | 10 | 50 | |
| 33 | 50% APP8 + 50% APP6 | 10 | 50 | |
| 34 | 50% APP2 + 50% APP6 | 10 | 80 | |
| 35 | 50% APP3 + 50% APP6 | 10 | 80 | 1 |
| 36 | 50% APP4 + 50% APP6 | 10 | 80 | 2 |
| 37 | 50% APP5 + 50% APP6 | 10 | 80 | 5 |
| 38 | 50% APP6 + 25% APP1 + 25% | 10 | 80 | 1 |
| | APP2 | | | |
| 39 | 50% APP7 + 50% APP6 | 10 | 90 | |
| 40 | 50% APP8 + 50% APP6 | 10 | about 100 | |

### Example 2

### Preparation of Particle Board Panels

For the production of the panels, the wood particles were treated with the solutions/suspensions of example 1. After being dipped and mixed, the particles were dried. The weight content APPX/Urea/MAPPX in the wood particles was, in a first set of tests, 3 kg per ton wood particles, 5 kg per ton wood particles and 8 kg per ton wood particles.

In a second set of tests, the wood particles mixed into a solution or suspension containing APPX and Urea were submitted to a heat treatment for initiating a reaction for producing MAPPX, so as to have about all the APPX converted into MAPPX.

The particle board panels were prepared in a lab-scale hot press, the panel having the following characteristics:
Length×width×thickness=500 mm×500 mm×19 mm
Density: 640 kg/m3
Press factor: 7.5 s/mm
Press pressure: 45 kg/cm2
Gluing rate: 8% (dry resin/dry wood)
Hardener SO4(NH4)2: 2% (dry hardener/dry resin)
Used resin: MUF with 4% of melamine and molar ratio

Formaldehyde/NH2=0.48

APPX and/or MAPPX: 3 or 5 or 8 kg (dry)/ton wood.

The boards thus manufactured were tested on strength (Internal Bond test, according to EN319, expressed in MPa or N/mm2) and on formaldehyde content (perforator test according to EN120 and expressed in mg of formaldehyde per 100 g of board).

The various panel boards have been tested. For comparison purposes, panels were prepared with particles boards dipped in a solution containing only urea (Panel Reference Urea—300 g urea per ton wood particles), with particles boards dipped in a solution containing only ammonium polyphosphate (panel reference APP—2700 g APP per ton wood particles). A further reference panel (basic reference panel) was prepared but without wood particles pretreated with APPX and/or Urea and/or MAPPX.

The results of said various tests are the followings:

a) the pretreatment of the wood particles with urea (panel reference urea with 300 g urea per ton wood particles) enables a reduction of about 5% of the formaldehyde content with reference to the Basic reference panel.
b) the pretreatment of the wood particles with APPX alone (Panel reference APPX with 2700 g APPX per ton wood particles) enables a reduction of the formaldehyde content of about 15% with respect to the Basic reference panel.
c) when pretreating wood particles with a solution or suspension of APPX and Urea (about 3 kg dry matter APPX and Urea per ton wood particles), a reduction of 35 to 40% of the formaldehyde content was achievable, while not affecting the internal bond strength.
d) when pretreating wood particles with a solution or suspension of APPX and Urea (about 5 kg dry matter APPX and Urea per ton wood particles), a reduction of 40 to 46% of the formaldehyde content was achievable, while not affecting the internal bond strength.
e) when preatreating wood particles with a solution or suspension containing MAPPX, the reduction of the formaldehyde content was higher than the reduction achieved by using the APPX and urea for preparing said MAPPX.
f) when forming the MAPPX in presence of the wood particles, the reduction of the formaldehyde content was at least equal to the reduction achieved by dipping wood particles into a solution or suspension containing MAPPX, but the internal bond strength of the panel with MAPPX formed in presence of the wood particles was at least equal to or better than the internal bond strength of the panel with wood particles dipped into a solution or suspension of MAPPX.

These examples are given as examples only.

What I claim is:

1. A method of production of formaldehyde laden products comprising at least (a) wood containing elements selected from the group consisting of wood containing particles, wood containing fibres and mixtures thereof, and (b) a formaldehyde based resin system, with reduced emission of formaldehyde during the production of said products, as well as from said products after their production, wherein the method comprises at least the following steps:
treating the wood containing elements with an aqueous composition comprising at least a reaction product (MAPP) of a reagent selected from the group consisting of melamine, urea and mixture thereof with an ammonium polyphosphate compound selected from the group consisting of ammonium polyphosphate having a water solubility at 25° C. greater than 0.5 g/100 ml, ammonium polyphosphate having a weight average particle size of less than 50 μm, and combinations thereof, wherein the said aqueous composition is selected from the group consisting of aqueous solution, aqueous suspension and a mix thereof, wherein the weight ratio ammonium polyphosphate/reagent used for the preparation of the said reaction product is comprised between 1:1 and 25:1,
mixing the wood containing elements treated with the said aqueous composition with a formaldehyde based resin system, and
hardening the formaldehyde based resin system mixed with the wood containing elements treated with the said aqueous composition.

2. The method of claim 1, wherein the said reaction product has a water solubility at 25° C. greater than 2 g/100 ml.

3. The method of claim 1, wherein the said reaction product has a water solubility greater than 10 g/100 ml.

4. The method of claim 1, wherein the said reaction product has a water solubility greater than 20 g/100 ml.

5. The method of claim 1, wherein after hardening the formaldehyde based resin system, the dry weight ratio reaction product/formaldehyde based resin system is comprised between 1:100 and 1:3.

6. The method of claim 1, wherein after hardening the formaldehyde based resin system, the dry weight ratio reaction product/formaldehyde based resin system is comprised between 1:20 and 1:4.

7. The method of claim 1, wherein after hardening the formaldehyde based resin system, the dry weight ratio reaction product/formaldehyde based resin system is comprised between 1:10 and 1:4.

8. The method of claim 1, wherein the said aqueous composition has a solid content in reaction product, ammonium polyphosphate, and reagent in the range from 50 to 70% by weight.

9. The method of claim 1, wherein the said aqueous composition contains at least the reaction product of ammonium polyphosphate with urea.

10. The method of claim 1, wherein the reaction product is the reaction product of urea with ammonium polyphosphate of formula 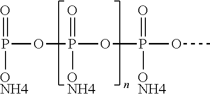
with n less than 10.

11. The method of claim 1, wherein the reaction product is the reaction product of urea with ammonium polyphosphate of formula 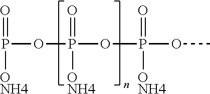
with n comprised between 2 and 8.

12. The method of claim 1, wherein the reaction product is the reaction product of urea with ammonium polyphosphate of formula 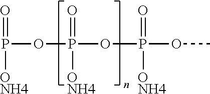
with n comprised between 2 and 6, and wherein the composition is suspension being substantially free of compound of formula 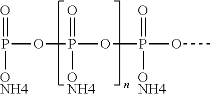
with n greater than 10.

13. The method of claim 1, wherein the reaction product is the reaction product of urea with ammonium polyphosphate of formula 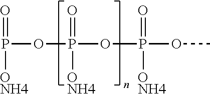
with n comprised between 2 and 6, and wherein the composition is suspension being substantially free of compound of formula 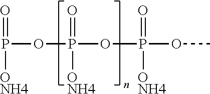
with n greater than 8.

14. The method of claim 1, wherein the wood containing elements are treated with the said aqueous composition comprising the said reaction product at a temperature comprised between 25° C. and 150° C.

15. The method of claim 1, wherein the wood containing elements are mixed with the formaldehyde based resin system for preparing after hardening of the said formaldehyde based resin system, wood containing boards selected from the group consisting of particle boards, medium density fiber boards, and plywood boards.

16. The method of claim 1, wherein the wood containing elements are mixed to an aqueous composition containing urea and ammonium polyphosphate during the at least partial reaction of urea with ammonium polyphosphate.

17. The method of claim 1, wherein the wood containing element are treated with the said aqueous composition comprising the said reaction product under an ammonia containing atmosphere.

18. The method of claim 1, wherein the wood containing elements after being treated with the said aqueous composition containing the said reaction product are removed from the aqueous composition, and then dried, before being mixed with formaldehyde based resin system.

19. The method of claim 1, wherein the wood containing elements after being treated with the said aqueous composition containing the said reaction product are removed from the aqueous composition, and then dried at a temperature below 150° C., before being mixed with formaldehyde based resin system.

20. The method of claim 1, wherein the wood containing elements after being treated with the said aqueous composition containing the said reaction product are removed from the aqueous composition, and then dried for reducing the water content of the treated wood containing element below 5% by weight, before mixing the dried treated wood containing elements with the formaldehyde based resin system.

21. The method of claim 1, wherein the wood containing elements are first treated an aqueous composition containing ammonium polyphosphate, then treated with an aqueous composition containing at least urea as reagent, wherein the reaction of the said ammonium polyphosphate with urea is started so as to form the said reaction product in the aqueous composition, and wherein the wood containing elements are treated with the aqueous composition containing the so prepared reaction product.

22. Formaldehyde laden products with a reduced emission of formaldehyde, said products comprising at least (a) wood containing elements selected from the group consisting of wood containing particles, wood containing fibers and mixtures thereof, and (b) a formaldehyde based resin system, wherein, before hardening of the formaldehyde based resin system and before mixing the wood containing elements with the formaldehyde based resin system, the wood containing elements are treated with an aqueous composition comprising at least a reaction product (MAPP) of a reagent selected from the group consisting of melamine, urea and mixture thereof with an ammonium polyphosphate compound selected from the group consisting of ammonium polyphosphate having a water solubility at 25° C. greater than 0.5 g/100 ml, ammonium polyphosphate having a weight average particle size of less than 50 μm, and combinations thereof, wherein the said aqueous composition is selected from the group consisting of aqueous solution, aqueous suspension and a mix thereof, wherein the weight ratio ammonium polyphosphate/reagent used for the preparation of the said reaction product is comprised between 1:1 and 25:1.

23. The products of claim 22, wherein the dry weight ratio reaction product/formaldehyde based resin system is comprised between 1:100 and 1:3.

24. The products of claim 22, wherein the dry weight ratio reaction product/formaldehyde based resin system is comprised between 1:20 and 1:4.

25. The products of claim 22, wherein the dry weight ratio reaction product/formaldehyde based resin system is comprised between 1:10 and 1:4.

26. The products of claim 1, wherein the reaction product is the reaction product of urea with ammonium polyphosphate of formula 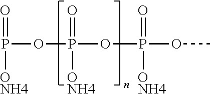
with n less than 10.

27. The products of claim 1, wherein the reaction product is the reaction product of urea with ammonium polyphosphate of formula 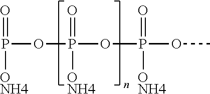
with n comprised between 2 and 8.
